(19) United States
(12) Patent Application Publication
(10) Pub. No.: US 2018/0356000 A1
(43) Pub. Date: Dec. 13, 2018

(54) NEW INTERLOCKING SOLUTION

(71) Applicant: ASTAVA BV, HS Meppel (NL)

(72) Inventors: Hendricus Johannes Richard BRUINS, AL Meppel (KR); Rob GASTHUIS, GL Vollenhove (KR); Theo Albert WUNNINK, AX Nijeveen (KR); Rob WESTENBRINK, HR Wapserveen (NL)

(21) Appl. No.: 16/060,173

(22) PCT Filed: Dec. 6, 2016
(86) PCT No.: PCT/IB2016/057380

§ 371 Date: Jun. 7, 2018

(51) Int. Cl. F16K 35/02; F16K 35/14; F15B 13/01

(52) U.S. Cl. CPC F16K 35/025; F15B 13/01; F16K 35/14

(57) ABSTRACT

The present invention provides a mechanical interlocked manifold for controlling a process medium flow between a fluid- or gas-system and, e.g., a sensor, as well as a method for calibrating, testing, replacing or repairing a measuring device interconnected to such a mechanical interlocked manifold.

### FIELD OF THE INVENTION

The present invention relates in general to interlocking mechanisms, specifically to mechanical forced interlocked mechanisms.

### BACKGROUND OF THE INVENTION

A multivalve manifold is defined as having at least two valves, typically plug or ball valves, located in a common manifold body. Such multivalve manifolds are ordinarily used with pressure and differential measuring instruments on pipelines, such as pressure-, temperature-pH-, and content-measuring instruments. For instance, flow rate in a pipeline may be measured by measuring the pressure at orifice plate forming a restrictive pressure drop in the pipeline. Accordingly, a multivalve manifold is connected across the orifice and the pressure measuring instrument.

Many multivalve manifolds are known in the art, each having its own customary or desirable normal operating mode for the valves, in order to prevent damage to the pipeline and/or to the measuring device interconnected thereto. However, confusion of the normal operating mode is all too easy and improper operation often results.

Normal operating mode requires to first isolate the pressures on both sides of the sensor or transducer, followed by gases removal, if present. Other valves connect the pressure lines for calibration, testing and service work on, e.g., the transducer. Several manifolds have been developed in order to limit the sequence in which the valves can be opened and closed to thereby minimize improper operation. Such manifolds permit opening and closing the different valves in a prescribed sequence. For instance, safety interlock systems between the valves with suitable labels indicative of the open and closed positions, can be used. However, labels do not actively prevent improper operation.

Other multivalve manifolds include a valve handle or stem protective systems including arrangements whereby the handles, stems, or both are selectively removed so that special tools (e.g. an Allen wrench) are required to open/close each valve. This interferes with ready access to the valve equipment. Moreover, it requires the use of specialty tools, which might be misplaced, and is thereby deficient in this regard.

Other multiple valves manifolds use specific valve lock mechanisms aimed at keeping the correct order of opening and closing each valve. However, in case said valve lock is not secure, then consequences might be serious. Moreover, usually such manifolds have a relatively complex structure, which complicates their operation and maintenance.

Accordingly, there exists a long felt need for an improved multivalve manifold which is safe, simple to use, and prevents human error during operation. Accordingly, the presently invented multivalve manifolds overcome all the disadvantages of the prior art devices, and are intended to help and satisfy this important long felt need.

### SUMMARY OF INVENTION

The present invention provides a mechanical interlocked manifold 100 for controlling a process medium between process and a sensor, comprising: (1) at least one inlet 12; (2) at least one outlet 31; (3) at least one interconnecting passageway extending between said at least one inlet 12 and said at least one outlet 31 as indicated, e.g., by a flow-diagram 30; (4) at least two valves 19,20 for opening and closing at least part of said at least one interconnecting passageway; (5) a predefined key-path 40 defining access points to the head of each of said at least two valves 19,20; and (6) a single non-removable operating key 11 movable within said predefined key-path 40, such as to set a single predefined operation order of said at least two valves 19,20.

In certain embodiments, the present invention provides a mechanical interlocked manifold 100 for controlling a process medium flow between a fluid- or gas-system and, e.g., a sensor, comprising: (1) at least one inlet 12 and at least one outlet 31 for connecting said mechanical interlocked manifold 100 to said fluid- or gas-system; (2) at least one interconnecting passageway extending between said at least one inlet 12 and said at least one outlet 31 as indicated, e.g., by a flow-diagram 30; (3) at least two valves 19,20 for opening and closing at least part of said at least one interconnecting passageway; (4) a predefined key-path 40 defining access points to the head of each of said at least two valves 19,20; and (5) a single non-removable operating key 11 movable within said predefined key-path 40, such as to set a single predefined operation order of said at least two valves 19,20.

The present invention further provides a method for calibrating, testing, replacing or repairing a measuring device interconnected to a mechanical interlocked manifold 100 of the invention, comprising the steps of: (a) interconnecting a mechanical interlocked manifold 100 of the invention to a liquid- or gas-system; (b) closing/opening each valve in said manifold 100 in the order defined according to a predefined key-path 40 by turning said single operating key 11 at each access point in said key-path; (c) after reaching the end of said key-path 40, performing the desired calibration, test, or measuring device replacement or repair; and (d) opening/closing each valve in a reverse order defined according to the predefined key-path 40 by turning said single operating key 11 at each access point, until said single operating key 11 reaches the starting point of said key-path 40.

### BRIEF DESCRIPTION OF DRAWINGS

The invention will be better understood upon reading the following non-limiting description of certain embodiments of the invention, reference being made to the accompanying drawings, in which:

FIGS. 1A-1D are sketches of a 5-way multivalve manifold according to the invention, in “closed” position. FIG. 1A is a front view; FIG. 1B is a 3-dimensional view;

FIG. 1C is a side view; and FIG. 1D is a bottom view.

FIGS. 2A-2B are sketches of a 5-way multivalve manifold according to the invention, in “opened” position. FIG. 2A is a front view; and FIG. 2B is a 3-dimensional view.

FIGS. 3A-3B are sketches of the single integratable key used in the multivalve manifold of the invention.

FIGS. 4A-4C are sketches of a 2-way multivalve manifold according to the invention, in a “closed” position. FIG. 4A is a front view; FIG. 4B is a 3-dimensional view, and FIG. 4C is a side view.

FIGS. 5A-5C are sketches of a 3-way multivalve manifold according to the invention, in a “closed” position. FIG. 5A is a front view; FIG. 5B is a 3-dimensional view, and FIG. 5C is a side view.

FIGS. 6A-6C are sketches of another configuration of a 3-way multivalve manifold according to the invention, in a “closed” position. FIG. 6A is a front view; FIG. 6B is a 3-dimensional view, and FIG. 6C is a side view.

### DETAILED DESCRIPTION OF THE INVENTION

The present invention aims at solving the problem of incorrect operation of multivalve manifolds. Accordingly, the present invention provides a mechanical interlocked manifold 100 for controlling a process medium between process and a sensor, said manifold comprises: (1) at least one inlet 12; (2) at least one outlet 31; (3) at least one interconnecting passageway extending between said at least one inlet and said at least one outlet as indicated, e.g., by a flow-diagram 30, which may be for instance engraved or laser-burned or stickered onto said manifold 100; (4) at least two valves 19,20 for opening and closing at least part of said at least one interconnecting passageway; (5) a predefined key-path 40 defining access points to each of said at least two valves 19,20; and (6) a single non-removable operating key 11 movable within said predefined key-path 40, such as to set a single predefined operation order of said at least two valves 19,20.

In another embodiment, the present invention provides a mechanical interlocked manifold 100 for controlling a process medium flow between a fluid- or gas-system and, e.g., a sensor, comprising: (1) at least one inlet 12 and at least one outlet 31 for connecting said mechanical interlocked manifold 100 to said fluid- or gas-system; (2) at least one interconnecting passageway extending between said at least one inlet 12 and said at least one outlet 31 as indicated, e.g., by a flow-diagram 30; (3) at least two valves 19,20 for opening and closing at least part of said at least one interconnecting passageway; (4) a predefined key-path 40 defining access points to the head of each of said at least two valves 19,20; and (5) a single non-removable operating key 11 movable within said predefined key-path 40, such as to set a single predefined operation order of said at least two valves 19,20.

In certain embodiments, the mechanical manifold 100 of the invention is used for interconnecting at least one system of flowing substance to a sensor. Such flowing substance may be for instance fluid or gas, or solids or gases in a fluidic state.

In a specific embodiment, the mechanical interlocked manifold 100 of the invention further comprises at least one venting opening 5 and at least one valve 22,23 for opening and closing said at least one venting opening 5.

In certain embodiments, the mechanical interlocked manifold 100 of the invention comprises 1, 2, 3, 4, 5, 6, 7, 8, 9, 10, or more, inlets. Accordingly, in certain embodiments, the mechanical interlocked manifold 100 comprises 1, 2, 3, 4, 5, 6, 7, 8, 9, 10, or more, outlets, respectively. In specific embodiments, the mechanical interlocked manifold 100 may comprise 1, 2, 3, 4, 5, 6, 7, 8, 9, 10, or more, interconnecting passageway extending between said at least one inlet and said at least one outlet as indicated.

In certain embodiments, the mechanical interlocked manifold 100 of the invention comprises 2, 3, 4, 5, 6, 7, 8, 9, 10, or more, valves.

In certain embodiments, said predefined key-path 40 is designed to force the user through a predefined procedure which is a fail-safe and correct operation manner, thereby avoiding possible human error. The predefined key-path 40 of the invention also enables to perform such predefined procedure without dependency on prior experience or acquaintance with the mechanical interlocked manifold 100 of the invention.

In certain embodiments, the head of each of said at least two valves 19,20 in said mechanical interlocked manifold 100 are positioned along the path defined by said predefined key-path 40, wherein the head 50, or attachment means, of said single operating key 11 is designed to fit said head of each of said at least two valves 19,20,21,22,23.

In yet another specific embodiment, each valve of said at least two valves 19,20, 21,22,23 in said mechanical interlocked manifold 100 cannot be turned—either into its open or into its closed state—before the preceding valve has been turned. For example, the user beginning from a closed-state of the manifold, in which all valves are closed, cannot open the 3^{rd} valve in the path before the 2^{nd} valve has been opened, and said 2^{nd} valve cannot be opened before the 1^{st} valve has been opened, and vice-versa. This can be achieved either by blocking and preventing passage of said operating key 11 over a valve without turning it, or by any suitable mechanism that prevents such turning with an external key (e.g. when attempting to deliberately sabotaging the system).

In certain embodiments, said at least two valves 19,20 in the mechanical interlocked manifold 100 of the invention can be opened or closed by turning said single operating key 11 once it reaches the head of said valves and connects thereto. The term “turn” means rotating the valve at any predetermined angle from a closed state to an open state, or vice-versa. Alternatively, said at least two valves 19,20 can be opened or closed by any other suitable configuration, such as pressing and re-pressing their head, or shifting it up-down or right-to-left. In a specific embodiment, said each of said least two valves 19,20 can be opened or closed only in a predefined order after closing or opening the previous valve, respectively.

In yet another embodiment, said single non-removable operating key 11 cannot be removed or extracted from the mechanical interlocked manifold 100, and can only be moved along said predefined key-path 40.

In certain embodiments, the mechanical interlocked manifold 100 of the invention further comprises at least one venting opening 5 and at least one additional valve 22,23 for opening and closing said at least one venting opening 5. These venting openings are designed to release gases accumulated in the system before exposing, e.g., the liquid in the system to, e.g., a measuring device connected to said manifold 100, since such gases might damage said measuring device. In specific embodiments, the mechanical interlocked manifold 100 comprises 1, 2, 3, 4, 5, 6, 7, 8, 9, 10, or more, venting openings. Accordingly, in certain embodiments, the mechanical interlocked manifold 100 comprises 1, 2, 3, 4, 5, 6, 7, 8, 9, 10, or more, valves for opening and closing said venting openings, respectively.

In certain embodiments, the mechanical interlocked manifold 100 of the invention further comprises at least one equalizing valve 21. The purpose of such an equalizing valve is to release pressure accumulated in the system and/or in the manifold 100 before exposing, e.g., a measuring device connected to the manifold to unsuitable pressure, which might damage it. In specific embodiments, the mechanical interlocked manifold 100 comprises 1, 2, 3, 4, 5, 6, 7, 8, 9, 10, or more, equalizing valves, depending on the number of pipes/tubes connected thereto in which pressure needs to be equalized.

Thus, in certain embodiments, the equalizing valve 21 in the mechanical interlock manifold 100 of the invention can be opened only after closing said vent valves 22,23. Accordingly, in yet another embodiment of the invention, said vent valves 22,23 cannot be opened when said equalizing valve 21 is open.

In certain embodiment,

In certain embodiments, the mechanical interlocked manifold 100 of the invention further comprises at least one opening 2 for interconnecting a sensor/tester or any other test or calibrating equipment which is needed for measuring or calibrating, e.g., a measuring device interconnected to said manifold 100. In specific embodiments, the mechanical interlocked manifold 100 comprises 1, 2, 3, 4, 5, 6, 7, 8, 9, 10, or more, openings.

In certain embodiments, said measuring device interconnected to the manifold 100 of the invention is designed to measure pressure, temperature, specific gases content and/or concentration, fluidity, viscosity, concentration, flow rate.

In certain embodiments, the mechanical interlocked manifold 100 of the invention further comprises a locking plate 6 locking said single operating key 11 in place in said mechanical manifold 100 and defining said predefined key-path 40. Said locking plate 6 may be manually removed, e.g., for maintenance purposes or fixing.

In certain embodiments, said locking plate 6 is designed to prevent release of said single integrated key 11 from the manifold 100, thereby preventing unintentional or intentional disoperation of the manifold.

In certain embodiments, said single operating key 11 is configured to slide in a predetermined key-path 40, without the ability of removing it therefrom, in order to complete a forced procedure to ensure safe and correct operating of the mechanical interlocked manifold 100 of the invention. As a result, the proper operation and availability of a measuring device interconnected thereto is no longer depending on human interface, thereby avoiding any human error.

In certain embodiments, the mechanical interlocked manifold 100 of the invention further comprises at least one wall mount means 13 enabling attaching/securing said mechanical interlocked manifold 100 onto, e.g., a wall a pipe or any location as needed. Said mechanical interlocked manifold 100 may further or alternatively comprise at least one system mount means 13′ enabling mounting and/or attaching said mechanical interlocked manifold 100 onto the tested system by, e.g., screws, banderole, etc.

In certain embodiments, the mechanical interlocked manifold 100 of the invention is suitable for assembly-onto and/or interlocking—with a liquid- or gas-system. In specific embodiments, said mechanical interlocked manifold 100 may be simultaneously interlocked with several liquid- or gas-systems, or with a system comprising a combination of at least one gas-system and at least one liquid-system.

In certain embodiments, the mechanical interlocked manifold 100 of the invention which is a 1-, 2-, 3-, 4-, 5-, 6-, 7-, 8-, 9-, or 10-way, or more, manifold in any flow-diagram available containing isolate, vent, equalize, drain and purge functionalities.

In a specific embodiment, the mechanical interlocked manifold 100 of the invention for controlling a process medium flow between a fluid- or gas-system and, e.g., a sensor, comprises: (1) at least one inlet 12 and at least one outlet 31 for connecting said mechanical interlocked manifold 100 to said fluid- or gas-system; (2) at least one interconnecting passageway extending between said at least one inlet 12 and said at least one outlet 31 as indicated, e.g., by a flow-diagram 30; (3) at least two valves 19,20 for opening and closing at least part of said at least one interconnecting passageway; (4) a predefined key-path 40 defining access points to the head of each of said at least two valves 19,20; (5) a single non-removable operating key 11 movable within said predefined key-path 40, such as to set a single predefined operation order of said at least two valves 19,20; (6) at least one venting opening 5, and at least one valve 22,23 for opening and closing said at least one venting opening 5; (7) at least one equalizing valve 21, which can be opened only after closing said vent valves 22,23, and wherein said vent valves 22,23 cannot be opened when said equalizing valve 21 is open; (8) at least one opening 2 for interconnecting test equipment; and (9) a locking plate 6 locking said single operating key 11 into said mechanical manifold 100 and defining said predefined key-path 40.

In another specific embodiment, the above mechanical interlocked manifold 100 comprises 1, 2, 3, 4 or 5 venting openings, and an equivalent number of valves for opening and closing said venting openings.

In yet another specific embodiment, the valves of the mechanical interlocked manifold 100 of the invention can be opened or closed by turning said single operating key 11, and can be opened or closed only in a predefined order after closing or opening a previous valve, respectively.

In a specific embodiment, the mechanical interlocked manifold 100 as described hereinabove is suitable for assembly/interlocking into a liquid- or gas-system.

In yet another specific embodiment, the mechanical interlocked manifold 100 as described hereinabove is a 1-, 2-, 3-, 4- or 5-way manifold in any flow-diagram available containing isolate, vent, equalize, drain and purge functionalities.

The present invention further provides a method for calibrating, testing, replacing or repairing a measuring and/or testing and/or calibrating device, interconnected to a mechanical interlocked manifold 100 of the invention, said method comprising the steps of: (a) first interconnecting a mechanical interlocked manifold 100 of the invention to a liquid- or gas-system; (b) closing/opening each valve in the order defined according to a predefined key-path 40 having access points for each valve in said manifold 100, by turning a single operating key 11 at each of said access points in said key-path 40; (c) after reaching the end of said key-path 40, performing the desired calibration, test, or measuring device replacement or repair; and (d) opening/closing each valve in said manifold 100 in a reverse order defined according to said predefined key-path 40 by turning said single operating key 11 at each access point, until said single operating key 11 reaches the starting point.

In certain embodiments, said single operating key 11 can move from one access point to the next along said predefined key-path 40 only after turning the valve in said access point to an open or closed position, accordingly.

In certain embodiments, the manifold 100 of the invention and its different components may be made from any suitable material, such as metal, metal-alloy, plastic(s), different polymers, etc., or any combination thereof. It should be noted that each component in the manifold 100 may be made from any material. The manifold 100, and its components, may be made in any known technique, such as molding, engraving, blow-molding, etc., wherein the different components may be assembled together by, e.g. screws, welding, or any other suitable manner.

The invention will now be illustrated by the following non-limiting examples and specific multivalve mechanical manifold structures.

### The Single Non-Removable Operating Key 11

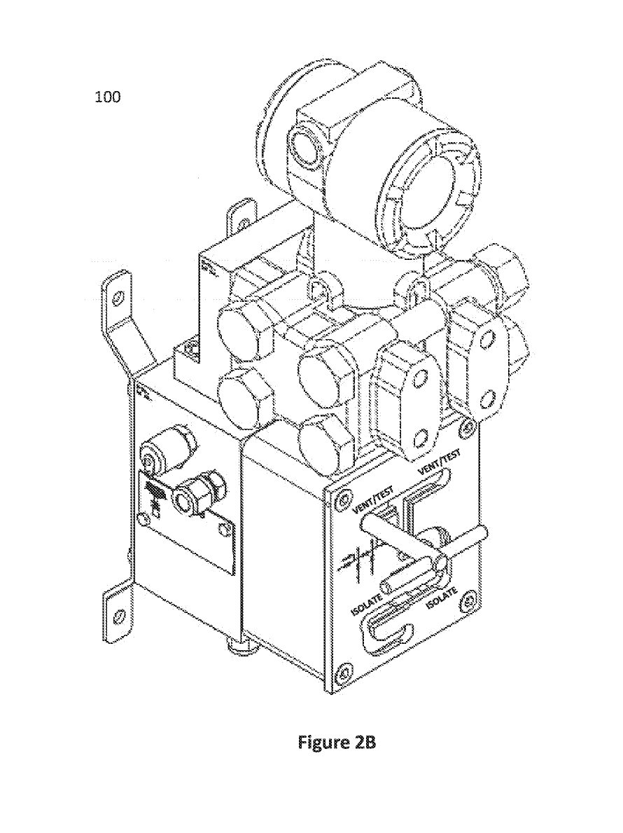

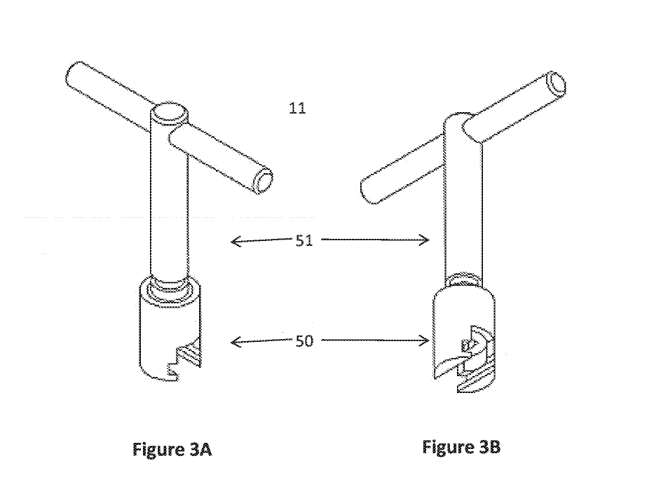

FIGS. 3A and 3B illustrate a single non-removable operating key 11 according to some embodiments of the invention. As seen in the figures, the key 11 has a head 50 wider than its elongated handle 51, thereby preventing extraction of the key 11 from and through the predefined key-path 40 in the locking plate 6 when assembled onto the mechanical manifold 100 of the invention.

The head of the key 50 has a unique engraving and/or protrusions and slots designed to fit onto the head of the valves in the mechanical manifold 100 of the invention. Moreover, the key 11 is designed so that it can embrace the head of said valves to allow the user to turn them into an open or closed position, and only then it can be released from the head of the valve and move along the predefined key-path 40 towards the next valve.

In certain embodiments, the operating key 11 is “T” shaped. Alternatively, the handlebar may be a circle or any other shape as desired by the end user. In a specific embodiment, the operating key 11 is configured of two separate parts, e.g., (i) a non-removable part comprising a head 50 and an elongated handle 51; and (ii) a handlebar which can be connected to said elongated handle 51 when needed.

### 2-Way Multivalve Mechanical Manifold

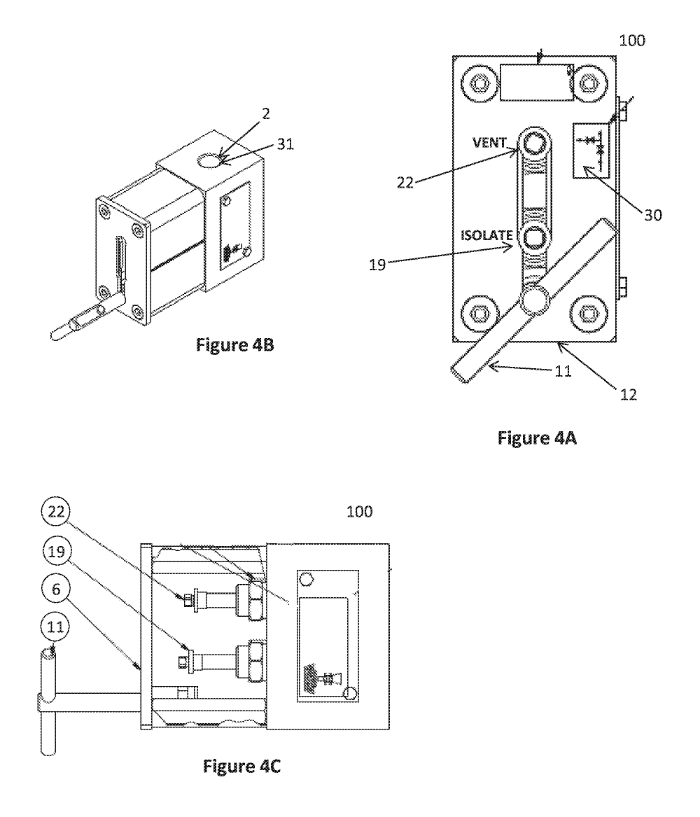

FIGS. 4A-4C illustrate a mechanical 2-way manifold 100 according to one embodiment of the invention which comprises (i) a single non-removable operating key 11; (ii) a locking plate 6 with a predefined key-path 40, holding said single non-removable operating key 11 in place and enabling it to move within said predefined key-path 40; (iii) one inlet 12 and one outlet 31; (iv) one interconnecting passageway extending between said inlet 12 and said outlet 31 as indicated by a flow-diagram 30 laser-carved onto the exterior part of said locking plate 6; (v) one valve 19 for opening and closing said interconnecting passageway; (vi) one opening 2 for interconnecting a measuring device; (vii) one venting opening 5 and an additional valve 22 for opening and closing it, wherein said key-path 40 sets a single predefined operation order of both valves; and (viii) one system mount means 13′ enabling mounting and/or attaching said mechanical interlocked manifold 100 onto the tested system.

### 3-Way Multivalve Mechanical Manifold

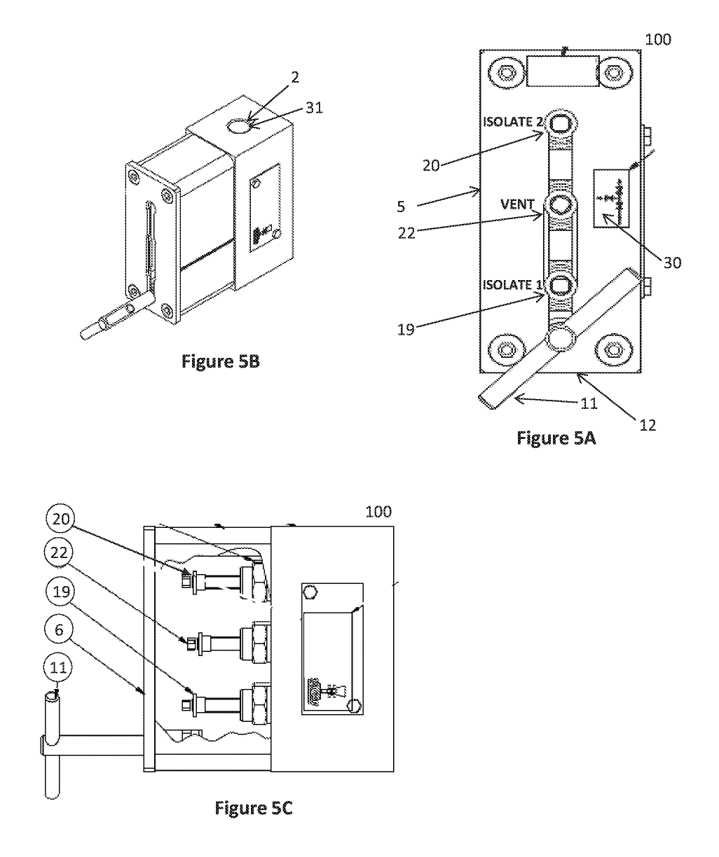

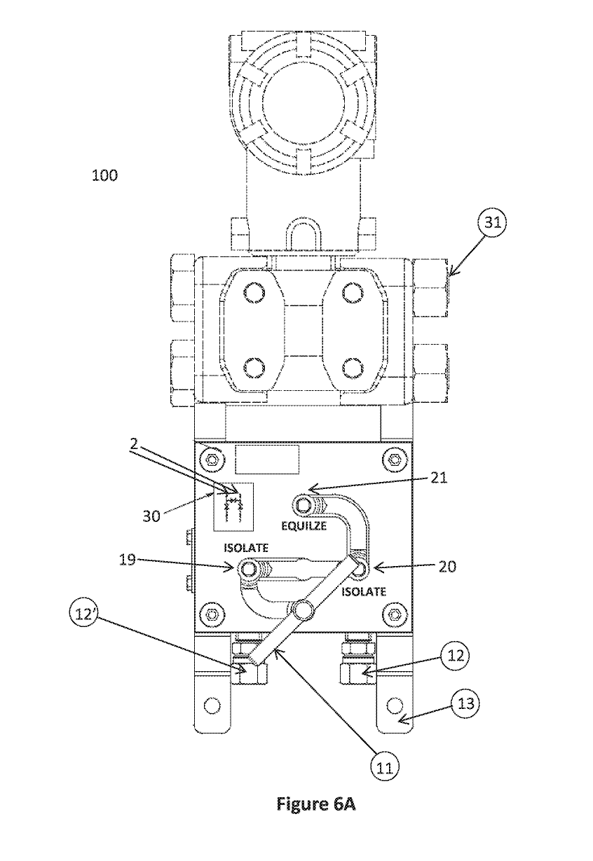

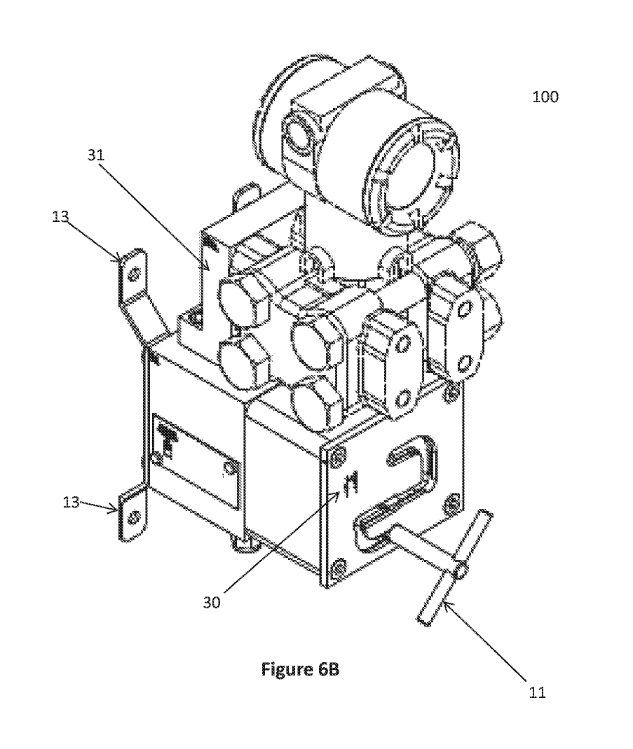

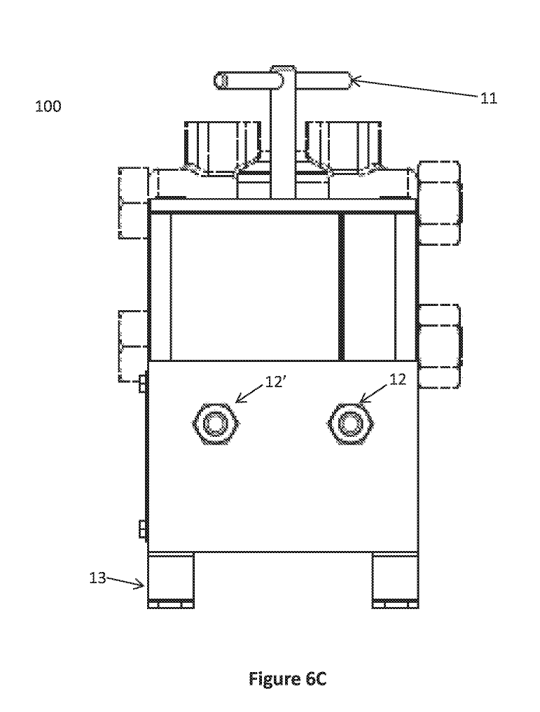

FIGS. 5A-5C and 6A-6C illustrate two configurations of a mechanical 3-way manifold 100 according to some embodiments of the invention, said manifolds 100 comprise (i) a single non-removable operating key 11; (ii) a locking plate 6 with a predefined key-path 40, holding said single non-removable operating key 11 in place and enabling it to move within said predefined key-path 40; (iii) two inlets 12,12′ and one outlet 31; (iv) one interconnecting passageway extending between said inlets and said outlet as indicated by a flow-diagram 30 laser-carved onto the exterior part of said locking plate 6; (v) two valves 19,20 for opening and closing said interconnecting passageway; (vi) a wall mount 13; (vii) two openings 2 for interconnecting a differential measuring device, and an additional valve 22 for opening and closing it, wherein said key-path 40 sets a single predefined operation order of all valves; and (viii) one system mount means 13′ enabling mounting and/or attaching said mechanical interlocked manifold 100 onto the tested system.

### 4-Way Multivalve Mechanical Manifold

A mechanical 4-way manifold according to one embodiment of the invention which comprises (i) a single non-removable operating key 11; (ii) a locking plate 6 with a predefined key-path 40, holding said single non-removable operating key 11 in place and enabling it to move within said predefined key-path 40; (iii) two inlets 12,12′ and one outlet 31; (iv) one interconnecting passageway extending between said inlets and said outlet as indicated by a flow-diagram 30 laser-carved onto the exterior part of said locking plate 6; (v) two valves 19,20 for opening and closing said interconnecting passageway; (vi) a wall mount 13; (vii) two openings 2 for interconnecting a measuring device; and (viii) two venting openings 5 and two additional valves for opening and closing them, wherein said key-path 40 sets a single predefined operation order of all four valves.

### 5-Way Multivalve Mechanical Manifold

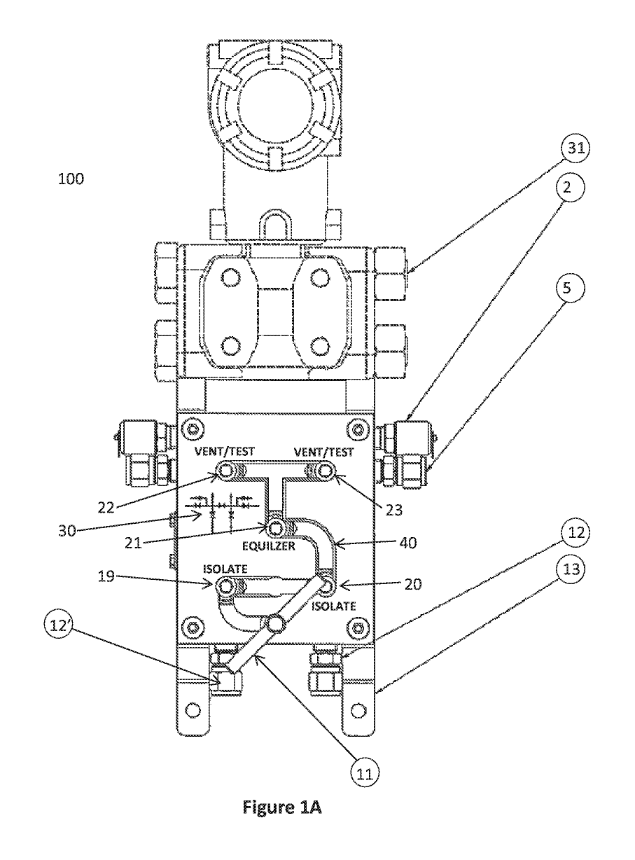

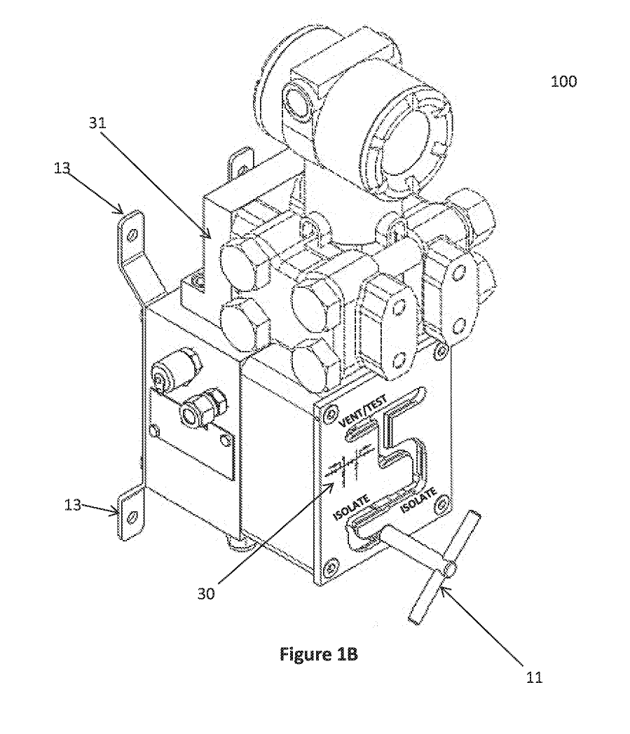

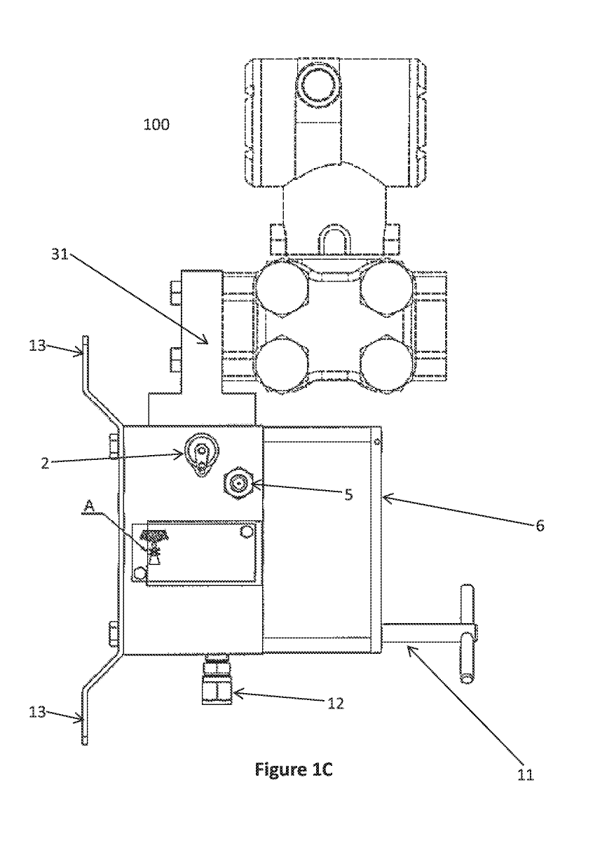

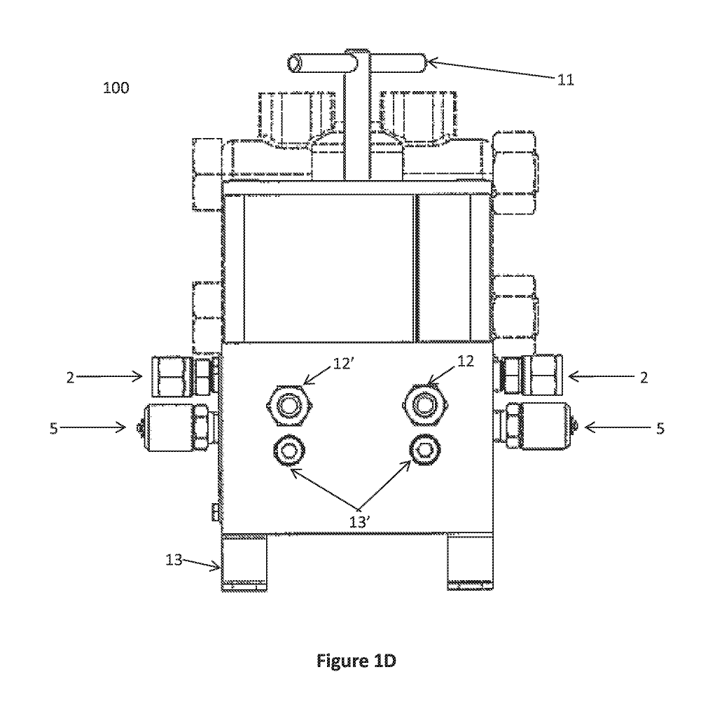

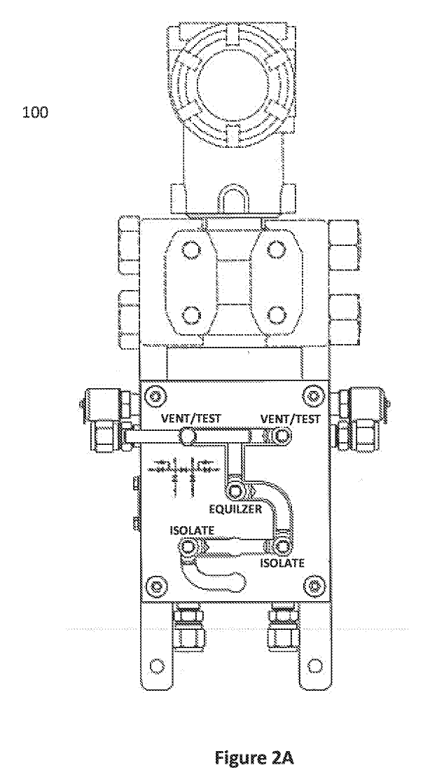

FIGS. 1 and 2 illustrate a mechanical manifold 100 according to one embodiment of the invention which comprises (i) a single non-removable operating key 11; (ii) a locking plate 6 with a predefined key-path 40, holding said single non-removable operating key 11 in place and enabling it to move within said predefined key-path 40; (iii) two inlets 12,12′ and one outlet 31; (iv) two interconnecting passageways extending between said inlets 12,12′ and said outlet 31 as indicated by a flow-diagram 30 laser-carved onto the exterior part of said locking plate 6; (v) three valves 19,20,21 for opening and closing said interconnecting passageways; (vi) a wall mount 13; (vii) two openings 2 (one on each side of the manifold) for interconnecting a measuring device; (viii) two venting openings 5 (one on each side of the manifold) and two vent valves 22,23 for opening and closing said venting openings 5, wherein said key-path 40 sets a single predefined operation order of all five valves; and (ix) two system mount means 13′ enabling mounting and/or attaching said mechanical interlocked manifold 100 onto the tested system.

1. A mechanical interlocked manifold for controlling a process medium flow between a fluid- or gas-system and, e.g., a sensor, comprising:
1) at least one inlet and at least one outlet for connecting said mechanical interlocked manifold to said fluid- or gas-system;
2) at least one interconnecting passageway extending between said at least one inlet and said at least one outlet as indicated, e.g., by a flow-diagram;
3) at least two valves for opening and closing at least part of said at least one interconnecting passageway;
4) a predefined key-path defining access points to the head of each of said at least two valves; and
5) a single non-removable operating key movable within said predefined key-path, such as to set a single predefined operation order of said at least two valves.

2. The mechanical interlocked manifold of claim 1, further comprising at least one venting opening and at least one valve for opening and closing said at least one venting opening.

3. The mechanical interlocked manifold of claim 2, comprising 1, 2, 3, 4 or 5 venting openings, and an equivalent number of valves for opening and closing said venting openings.

4. The mechanical interlocked manifold of claim 2, further comprising at least one equalizing valve.

5. The mechanical interlock manifold of claim 4, wherein said equalizing valve can be opened only after closing said vent valves.

6. The mechanical interlock manifold of claim 5, wherein said vent valves cannot be opened when said equalizing valve is open.

7. The mechanical interlocked manifold of claim 1, wherein said valves can be opened or closed by turning said single operating key.

8. The mechanical interlocked manifold of claim 7, wherein each of said valves can be opened or closed only in a predefined order after closing or opening a previous valve, respectively.

9. The mechanical interlocked manifold of claim 1, further comprising at least one opening for interconnecting test equipment.

10. The mechanical interlocked manifold of claim 1, further comprising a locking plate locking said single operating key into said mechanical manifold and defining said predefined key-path.

11. The mechanical interlocked manifold of claim 1, which is suitable for assembly/interlocking into a liquid- or gas-system.

12. The mechanical interlocked manifold of claim 1, wherein said manifold is a 1-, 2-, 3-, 4- or 5-way manifold in any flow-diagram available containing isolate, vent, equalize, drain and purge functionalities.

13. The mechanical interlocked manifold of claim 1, further comprising:
at least one venting opening, and at least one valve for opening and closing said at least one venting opening;
at least one equalizing valve, which can be opened only after closing said vent valves, and wherein said vent valves cannot be opened when said equalizing valve is open;
at least one opening for interconnecting test equipment; and
a locking plate locking said single operating key into said mechanical manifold and defining said predefined key-path.

14. The mechanical interlocked manifold of claim 13, comprising 1, 2, 3, 4 or 5 venting openings, and an equivalent number of valves for opening and closing said venting openings.

15. The mechanical interlocked manifold of claim 13, wherein said valves can be opened or closed by turning said single operating key and can be opened or closed only in a predefined order after closing or opening a previous valve, respectively.

16. The mechanical interlocked manifold of claim 13, which is suitable for assembly/interlocking into a liquid- or gas-system.

17. The mechanical interlocked manifold of claim 13, wherein said manifold is a 1-, 2-, 3-, 4- or 5-way manifold in any flow-diagram available containing isolate, vent, equalize, drain and purge functionalities.

18. A method for calibrating, testing, replacing or repairing a measuring device interconnected to a mechanical interlocked manifold of the invention, comprising the steps of:
a) interconnecting a mechanical interlocked manifold of claim 1 to a liquid- or gas-system;
b) closing/opening each valve in said manifold in the order defined according to a predefined key-path by turning said single operating key at each access point in said key-path;
c) after reaching the end of said key-path, performing the desired calibration, test, or measuring device replacement or repair; and
d) opening/closing each valve in a reverse order defined according to the predefined key-path by turning said single operating key at each access point, until said single operating key reaches the starting point.

19. The method of claim 18, wherein said key can move from one access point to the other only after turning the valve in said access point to an opened or closed position.
